(19) United States
(12) Patent Application Publication
(10) Pub. No.: US 2008/0240322 A1
(43) Pub. Date: Oct. 2, 2008

(54) Communication controller and method for saving power in transmitting and receiving

(75) Inventor: Masaaki Date, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/078,270

(22) Filed: Mar. 28, 2008

(30) Foreign Application Priority Data
Apr. 2, 2007 (JP) 2007-096476

(51) Int. Cl. H04L 7/00

(52) U.S. Cl. 375/356

(57) ABSTRACT

A communication controller mounted on a node includes a data communicator transmitting a data signal, a transmission cycle information decider deciding transmission cycle information of that node on the basis of occurrence frequency of traffic, and a timing control signal receiver receiving a timing control signal. The timing control signal is indicative of a communication timing of the node. The communication controller further includes a communication timing calculator calculating a communication timing of that node in response to reception of the timing control signal, a timing control signal transmitter transmitting a merged signal of a timing control signal and the transmission cycle information to neighboring nodes, and a transmission-reception interruption controller determining whether or not to interrupt transmission and/or reception of the data signal and/or the timing control signal in that node, on the basis of transmission cycle information of the neighboring nodes or the node itself.

### BACKGROUND OF THE INVENTION

1. Field of the Invention

The present invention relates to an apparatus for, and a method of controlling communications. More specifically, the present invention is relates to such an apparatus and a method of avoiding collision between communication data due to radio interference, particularly in the case where a plurality of network nodes transmit and receive data between each other, which are dispersedly disposed in space and installed on mobile bodies, for instance, in a system constituted by a plurality of communication devices connected to a sensor network, an ad hoc network or a local area network (LAN).

2. Description of the Background Art

There are various methods for avoiding the collision between communication data, in which network nodes adjust mutually communication timing autonomously and dispersedly without a central administrative server. Such methods are disclosed in U.S. Patent application publication Nos. US 2005/0190796 A1, US 2006/0114841 A1, US 2006/0114840 A1 and US 2006/0171409 A1, all to Date et al., and US 2006/0171421 A1 to Matsunaga et al., and Japanese patent laid-open publication Nos. 2006-74617, 2006-74619 and 2005-347951.

The above-mentioned seven patent publications, excluding the '951 publication, disclose techniques relating to communication controllers and methods therefor that avoid the collision between communication data due to radio interference by allocating time slots autonomously and dispersedly, in the case where a plurality of nodes transmit and receive data between each other, which are dispersedly disposed in space and installed on mobile bodies, for instance, in a system constituted by a plurality of communication devices connected to a sensor network, an ad hoc network or a local area network.

In the communication controllers and control methods disclosed in those seven patent publications, each node transmits and receives an impulse signal, such as a timing control signal indicative of the data transmission timing of that specific node, periodically to and from its neighboring nodes, whereby the nodes mutually adjust their communication timings. This enables the time slot allocation which divides one cycle, i.e. transmission cycle of a timing control signal, into approximately equal time slots, between nodes lying within the service range, or interaction range, in which the timing control signals are available.

The '951 Japanese publication indicated above discloses a technique by which each node can save power when using the communication controllers and control methods taught in the aforementioned seven patent publications. In the method disclosed by this Japanese patent publication, during the above-described one cycle, time intervals other than time slots in which a data signal is transmitted and received are identified and a data communicator goes to its interrupted state, i.e. power-off state. This prevents the data communicator from going to its wait state for the data reception during the time intervals in which reception of data signals is not performed. Consequently, wasteful power consumption due to the wait state is avoided.

The technique taught in the '951 Japanese patent publication is advantageous in that the receiver of a receiving node goes to its off state without an instruction of the communication timing from the administrative node. However, there are demands for further power saving in the reception operation of each node.

For instance, the conventional communication controllers taught in the aforementioned eight patent publications perform the transmission and reception operations of timing control signals and data signals even when there are time periods during which no traffic occurs. For that reason, even when no data signal is transmitted and received, the data communicator goes to its wait state for the data reception and continues to transmit and receive timing control signals.

Consequently, the signal transmitter and receiver, corresponding to the data communicator, impulse signal transmitter and impulse signal receiver disclosed in the aforementioned seven patent publications, consume power wastefully.

Particularly, under the circumstance where traffic varies irregularly with time, it is fairly difficult to find how frequently a node itself and its neighboring nodes cause traffic to occur. If this is found, time slots can be allocated to each node in accordance with the occurrence frequency of traffic in the node, whereby power saving can be expected.

### SUMMARY OF THE INVENTION

It is an object of the present invention to provide a communication controller and a communication control method that are capable of interchanging information on the occurrence frequencies of traffic between network nodes on a communication system, i.e. network, and capable of saving the power of a signal transmitter and receiver by performing or interrupting transmission and reception operations in accordance with the interchanged information on traffic frequency.

In accordance with the present invention, there is provided a communication controller mounted on a network node constituting a communication system. The communication controller comprises: a data communicator for transmitting and receiving a data signal to and from other nodes; a transmission cycle information decider for deciding transmission cycle information of the node on which the controller is mounted on the basis of occurrence frequency of traffic in the data communicator; a timing control signal receiver for receiving a timing control signal transmitted from one or more neighboring nodes, the timing control signal being indicative of a communication timing of the neighboring node; a communication timing calculator for calculating a communication timing of the node on which the controller is mounted in accordance with a communication timing calculation rule, in response to reception of the timing control signal from the neighboring node; a timing control signal transmitter for transmitting a merged signal of a timing control signal indicative of a communication timing of the node on which the controller is mounted and at least the transmission cycle information to the neighboring nodes; and a transmission-reception interruption controller for determining whether or not to interrupt transmission and/or reception of the data signal and/or the timing control signal in the node on which the communication controller is mounted on the basis of transmission cycle information of the neighboring node contained in the timing control signal from the neighboring node or the transmission cycle information of the node on which the communication controller is mounted.

In accordance with the present invention, there is provided a node comprising the communication controller described above.

In accordance with the present invention, there is provided a communication system comprising the node described above.

In accordance with the present invention, there is provided a method controlling communication in a communication controller mounted on a network node constituting a communication system. The method includes the steps of: transmitting and receiving a data signal to and from other nodes by a data communicator; deciding transmission cycle information of the network node by a transmission cycle information decider on the basis of occurrence frequency of traffic in the data communicator; receiving, in a timing control signal receiver, a timing control signal transmitted from one or more neighboring nodes, the timing control signal being indicative of a communication timing of the neighboring node; calculating a communication timing of the network node by a communication timing calculator in accordance with a communication timing calculation rule, in response to reception of the timing control signal from the neighboring node; transmitting a merged signal of a timing control signal indicative of a communication timing of the network node and at least the transmission cycle information from a timing control signal transmitter to the neighboring nodes; and determining by a transmission-reception interruption controller whether or not to interrupt transmission and/or reception of the data signal and/or the timing control signal in the network node on the basis of transmission cycle information of the neighboring node contained in the timing control signal from the neighboring node or the transmission cycle information of the network node.

In accordance with the present invention, there is also provided a communication control program executable on a computer serving as a communication controller mounted on a network node constituting a communication system. The program causes a computer to function as: a data communicator for transmitting and receiving a data signal to and from other nodes; a transmission cycle information decider for deciding transmission cycle information of the node on which the controller is mounted on the basis of occurrence frequency of traffic in the data communicator; a timing control signal receiver for receiving a timing control signal transmitted from one or more neighboring nodes, the timing control signal being indicative of a communication timing of the neighboring node; a communication timing calculator for calculating a communication timing of the node on which the controller is mounted in accordance with a communication timing calculation rule, in response to reception of the timing control signal from the neighboring node; a timing control signal transmitter for transmitting a merged signal of a timing control signal indicative of a communication timing of the node on which the controller is mounted and at least the transmission cycle information to the neighboring nodes; and a transmission-reception interruption controller for determining whether or not to interrupt transmission and/or reception of the data signal and/or the timing control signal in the node on which the communication controller is mounted on the basis of transmission cycle information of the neighboring node contained in the timing control signal of the neighboring node, or the transmission cycle information of the node on which the communication controller is mounted.

The present invention can interchange information on the frequencies of traffic between nodes on a communication system, or network, and, by performing or interrupting transmission and reception operations in accordance with the interrupted traffic frequency, can achieve the power saving of the signal transmitter and receiver.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the internal structure of a network node in accordance with an illustrative embodiment of the present invention;

FIGS. 2A and 2B are an explanatory diagram useful for understanding an arrangement of the node and a control of signal reception, respectively, in accordance with the illustrative embodiment;

FIG. 3 is a flow chart useful for understanding a transmission of data signals and timing control signals on the basis of the transmission cycle information of a node itself in accordance with the illustrative embodiment; and

FIG. 4 is a flow chart useful for understanding a reception of data signals and/or timing control signals on the basis of the transmission cycle information of another node in accordance with the illustrative embodiment.

### DESCRIPTION OF THE PREFERRED EMBODIMENT

An illustrative embodiment of a communication controller in a telecommunications system in accordance with the present invention will be hereinafter described in detail with reference to the accompanying drawings. In the illustrative embodiment, a plurality of network nodes are dispersedly disposed in space to constitute a sensor network.

The illustrative embodiment has the feature that a transmission-cycle decider and a transmission-reception interruption controller which are to be described later so that each network node autonomously interrupts the transmission and reception operations of its signal transmitter and receiver in accordance with the occurrence frequency of traffic in each node on the network.

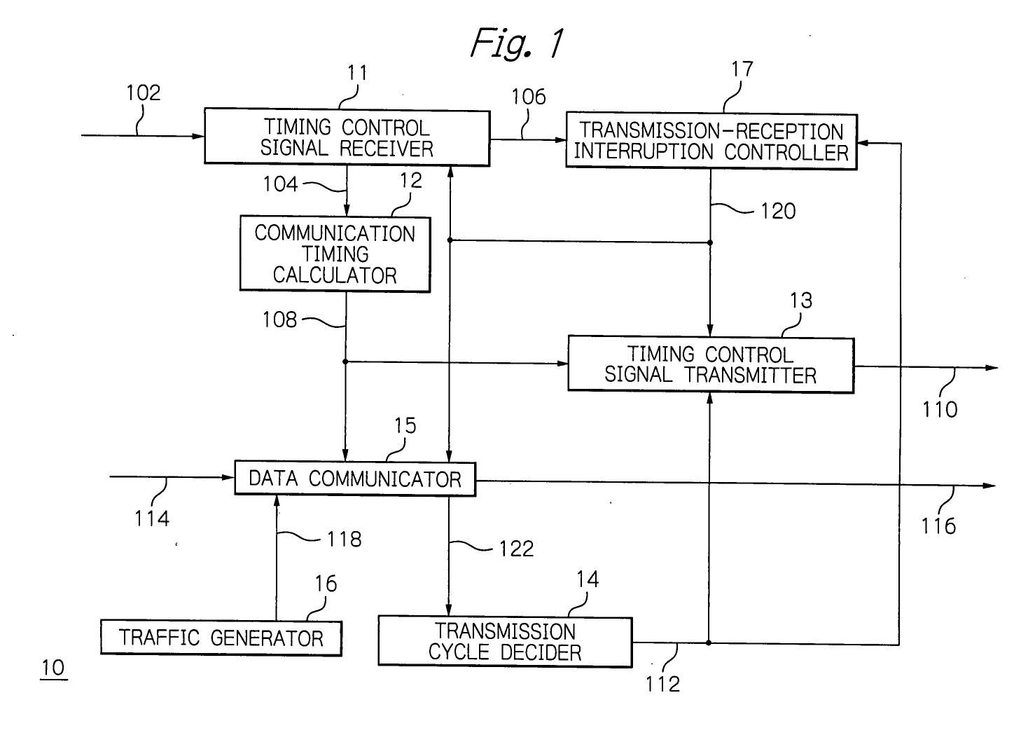

FIG. 1 is a schematic block diagram showing internal structure of each node dispersedly disposed in space in accordance with the illustrative embodiment of the present invention. As shown in FIG. 1, the network node 10 essentially includes a timing control signal receiver 11, a communication timing calculator 12, a timing control signal transmitter 13, a transmission cycle decider 14, a data communicator 15, a traffic generator 16, and a transmission-reception interruption controller 17 which are interconnected as illustrated.

A representative example of the traffic generator 16 is a sensor module that senses physically or chemically environment information, e.g. the intensity of sound, vibration or oscillation, the concentration of chemical, or temperature. In the illustrative embodiment, the traffic to be generated by the traffic generator 16 is all of the transmission data generated in a specific node, such as sensor information and internal condition in that node, i.e. observation data, and does not include communication data received from other nodes and to be transferred. The traffic generator 16 is adapted to output generated observation data 118 to the data communicator 15.

The communication timing calculator 12, if an input timing control signal 102 is received by the timing control signal receiver 11, is adapted to receive that input timing control signal 102 from the timing control signal receiver 11 as a control signal 104 indicative of the transmission timing of another node, perform an arithmetic process for adjusting communication timings between the nodes, and output phase information 108 on the resultant communication timing of the node on which the calculator 12 is provided to the timing control signal transmitter 13 and data communicator 15. Note that even when an input timing control signal is not received by the timing control signal receiver 11, the communication timing calculator 12 is adapted to output the phase information 108.

The arithmetic process, which calculates phase information 108, also called a phase signal, indicative of the communication timing of the node itself, can be carried out by making use of any one of the methods disclosed in the aforementioned eight publications.

More specifically, assuming the phase value of the phase signal of that specific node, referred to as node i in the illustrative embodiment, at time t is represented by θi(t), the communication timing calculator 12 is adapted to vary the phase signal (=θi(t)) in a nonlinear oscillation rhythm, in response to the timing at which a control signal 104 indicative of the transmission timing of another node is received.

This variation in the phase signal realizes the nonlinear characteristic of neighboring nodes trying to become opposite in phase (or in oscillation phase) to each other, or trying to become different in phase from each other, and tries to avoid collision by using that characteristic. More specifically, the variation in the phase signal tries to form an appropriate time relationship (difference in time) in such a way that the transmission timings of the output timing control signals 110 of the neighboring nodes do not collide with one another.

The data communicator 15 is adapted to transmit an output data signal 116 on the basis of the phase information 108 from the communication timing calculator 12.

The transmission time slot allocated to the data communicator 15 is the time interval in which the phase θi(t) of the phase signal (phase information) is between δ₁ and αβ₁−δ₂, namely the time interval between δ₁≦θi(t)≦β₁−δ₂. The start of the time slot, at which the value of the phase signal is δ₁, is the instant at which the transmission of the output timing control signal 110 by the timing control signal transmitter 13 is completed, while the end of the time slot, at which the value of the phase signal is β₁−β₂, is a point that is δ₂ before the instant at which the first input timing control signal 102 is input for each cycle of the phase signal. The notation δ₁ or δ₂ is a phase width that corresponds to a very short time for assuring that in the radio space in the vicinity of each node 10, a timing control signal 110, transmitted from a node itself or another node, and a data signal 116, transmitted from a node itself or another node, will not exist at the same time. The phases width δ₁ and δ₂ can be experimentally determined, for example, under the circumstance where the nodes 10 have been installed.

The data signal 116 to be transmitted by the data communicator 15 is a merged signal 116 of the observation data 118 from the traffic generator 16 and the input data signal 114 received from another node, i.e. the observation data generated in the traffic generator of the other node, over one cycle.

The data communicator 15 is also adapted to feed the data size of the merged signal 116 to the transmission cycle decider 14 as a communication data quantity 122. In the case where a data signal 116 is transmitted as a packet, a data signal 116 to be transmitted at a certain communication timing may be constituted by a plurality of packets in accordance with the data size. In this case, the data communicator 15 may inform the transmission cycle decider 14 about the number of packets so that the decider 14 decides a transmission cycle on the basis of the packet number.

The data communicator 15 is further adapted to receive the instruction 120 to interrupt the transmission and reception of a data signal from the transmission-reception interruption controller 17 so as to interrupt the signal 116 transmission and reception during a predetermined interrupting time in response to the instruction 120.

The timing control signal transmitter 13 is adapted to generate timing control information 110 on the transmission timing of that node including that transmitter 13 on the basis of the phase information 108 from the communication timing calculator 12 and transmit this timing control information 110.

At that time, the timing control signal transmitter 13 is adapted to receive the transmission cycle information 112 of that specific node from the transmission cycle decider 14, then attach the transmission cycle information 112 of that node and destination information to a timing control signal 110, and transmit the information-attached signal 110.

The “transmission cycle information of a specific node” refers to the occurrence frequency of traffic and represents at the ratio of what times to what cycles the data communicator 15 of the specific node transmits a data signal. The “destination information” represents the destination of a data signal that is transmitted by the data communicator 15. The destination information can be set, for instance, by human, or by using a destination acquired from the data communicator 15 when transmitting a data signal.

Thus, since the timing control signal transmitter 13 sends out the transmission cycle information of the node including the transmitter 13 along with the timing control signal 110, the transmitter 13 is able to inform neighboring nodes about the frequency with which traffic occurs in that node.

The timing control signal transmitter 13 is also adapted to receive the instruction 120 to interrupt the transmission of the timing control signal from the transmission-reception interruption controller 17 so as to interrupt the transmission during a predetermined interrupting time in response to the instruction 120.

Note that the transmission of a timing control signal 110 by the timing control signal transmitter 13, as with the techniques described in the aforementioned eight publications, is performed when the phase signal reaches a predetermined phase α (0≦α≦2π). It is preferable that the predetermined phase. α be the same in the entire system. In the following description, the predetermined phase α is assumed to be zero in the entire system. For example, in the case where node i and node j are in a steady state, the two phase signals are shifted from each other by a phase n. Therefore, assuming the phase α is zero in the entire system, the transmission timing of the output timing control signal 110 from node i and the transmission timing of the output timing control signal 110 from node j are to be shifted from each other by n.

The timing control signal receiver 11 is adapted to receive as an input timing control signal 102 a timing control signal transmitted by another node existing in the vicinity of the node in which the receiver 12 is installed, and feed the received timing control signal to the communication timing calculator 12 as a control signal 104 indicative of the transmission timing of the other node.

The timing control signal receiver 11 is also adapted to extract the transmission cycle information of the other node, equivalent to the transmission cycle information of that node as viewed from the transmission side node, from the received timing control signal 102, and feed the extracted “transmission cycle information 106 of the other node” to the transmission-reception interruption controller 17.

The timing control signal receiver 11 is further adapted to receive the instruction 120 to interrupt the reception of the input timing control signal 102 from the transmission-reception interruption controller 17 so as to interrupt the reception from the other node during a predetermined interrupting time in response to the instruction 120.

The transmission cycle decider 14 is adapted to receive a communication data quantity 122 that is output during one cycle from the data communicator 15, then observe this communication data quantity over N cycles, and calculate the occurrence frequency of a data signal that should be transmitted. The transmission cycle decider 14 is also adapted to feed the resultant occurrence frequency of the data signal to the timing control signal transmitter 13 and transmission-reception interruption controller 17 as the transmission cycle information 112 of that node including the cycle decider 14. Note that N is a positive integer and is equal to one or more, and is a parameter that is experimentally determined.

With regard to a method for calculating the occurrence frequency of the data signal, transmission cycle information, by the transmission cycle decider 14, it is possible to apply a method for averaging the communication data quantities 122 of the data communicator 15 by N cycles and for utilizing the resultant average value as the transmission cycle information 112. Therefore, for example, in the event that a data signal 116 occurs at the ratio of one to three cycles, the transmission cycle of that node is determined to be once to three cycles.

Thus, the transmission cycle decider 14 can calculate the occurrence frequency of a transmission data signal 116 in N cycles and determine on the basis of the calculation results at the ratio of one to what cycles (generally, at the ratio of Y to X cycles) a data signal is transmitted. Note that X and Y are parameters that are experimentally determined.

The transmission-reception interruption controller 17 is adapted to receive the transmission cycle information 106 of the other node received from the timing control signal receiver 11 and perform the interruption control of the reception of the data signal 116 and timing control signal 110 transmitted from the other node on the basis of the transmission cycle information 106.

The transmission-reception interruption controller 17 is also adapted to receive the transmission cycle information 112 of the node including the controller 17 from the transmission cycle decider 14 and perform the interruption control the transmission of the data signal 116 and timing control signal 110 of that node on the basis of the transmission cycle information 112.

The interruption control is performed by outputting an interrupting signal 120 indicative of that effect to the timing control signal receiver 11, timing control signal transmitter 13, and data communicator 15. A specific method of the interruption control will be hereinafter described in detail.

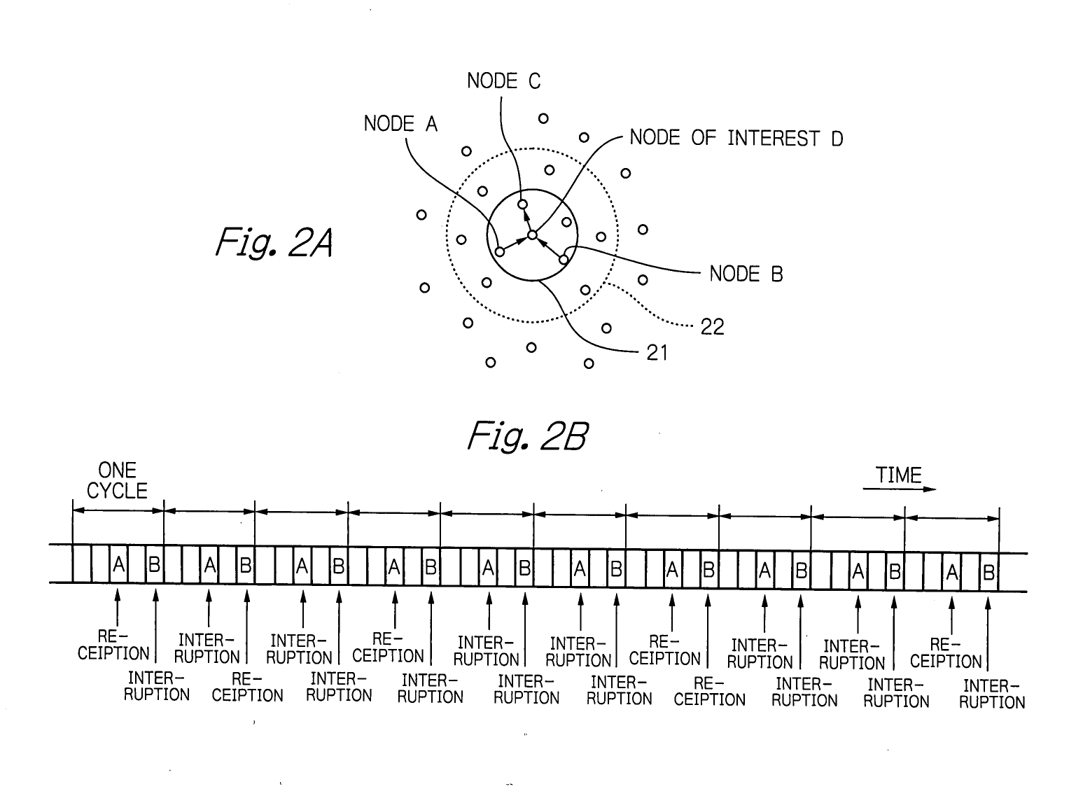

Operation in transmitting and receiving signals between nodes dispersedly disposed in space will be described with reference to the drawings. With reference to FIG. 2A, there are shown nodes dispersedly disposed in space. In the figure, small circles denote nodes, e.g. sensor nodes, a solid line circle 21 denotes the range in which data signals 116 of an object node D lying in the center are available, i.e. reachable range, and a dot-line circle 22 denotes the reachable range of timing control signals 110 of the object node D.

In FIG. 2A, assume that nodes A and B transmit data signals 116 with the object node D as its destination. The object node D is also assumed to transmit data signals 116 with node C as its destination.

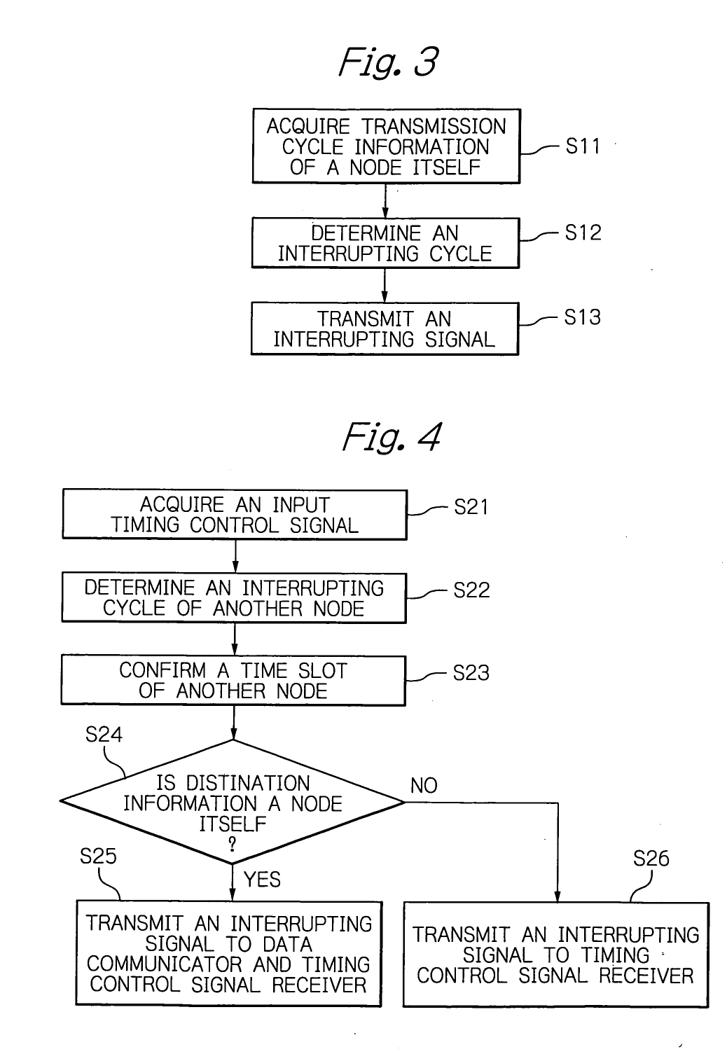

Initially, the operation of communication control of the illustrative embodiment will be described with reference to FIGS. 1 and 3 as an example of controlling the transmission of data signals and timing control signals in a node itself on the basis of the transmission cycle information of the specific node.

It is further assumed that timing control signals are transmitted and received between a plurality of nodes shown in FIG. 2A. Based on this assumption, communication-timing between the nodes is adjusted mutually, i.e. each node performs a mutual adjustment of the communication-timing. The reachable range of timing control signals 110 is made wider than that of data signals 116. For instance, the ratio of reachable distances is about twice. These reachable ranges are determined so as to avoid occurring collisions due to transmission from hidden terminals. However, timing control signals 110 do not always need to be reached to their destinations in one hop. For example, they may be reached in two hops via a relay node. In that case, the relay node generates a virtual phase relative to the departure node, applies the virtual phase to the timing control signal and transmits the applied timing control signal 110 at the timing of the relay node itself.

If the mutual adjustment of the communication-timing is converged in each node, the node becomes, within one cycle, condition to acquire a time slot for transmitting a data signal 116.

Thereafter, the data communicator 15 of each node generates a transmission data signal 116 merged in one cycle on the basis of the input data signal 114 from another node and the observation data 118 from the traffic generator 16. At the same time, the data size of the data signal 116 merged in one cycle is fed as a communication data quantity 122 from the data communicator 15 to the transmission cycle decider 14.

After receiving the communication data quantity 122, the transmission cycle decider 14 determines transmission cycle information calculated in accordance with a predetermined calculation method and then feeds that information 112 to the timing control signal transmitter 13 and transmission-reception interruption controller 17.

In response to the transmission cycle information 112 from the transmission cycle decider 14, the timing control signal transmitter 13 transmits a timing control signal 110, along with the transmission cycle information 112 of that node itself and destination information.

In this manner, each node transmits the timing control signal 110 which contains the transmission cycle information 112 of that node, whereby it can inform other nodes about information of at the ratio of one to what cycles a data signal 116 is transmitted.

Moreover, in response to the transmission cycle information 112 from the transmission cycle decider 14, the transmission-reception interruption controller 17 carries out the processing steps shown in FIG. 3.

FIG. 3 is a flow chart for use in understanding the processing steps that are executed by the transmission-reception interruption controller 17 when transmitting a data signal and a timing control signal. Now, in step S11, the transmission-reception interruption controller 17 acquires the transmission cycle information 112. The transmission-reception interruption controller 17 then determines, on the basis of the contents of the transmission cycle information 112 of that node itself, a cycle during which the transmission of a data signal 116 and a timing control signal 110 is interrupted (step S12). The controller 17 also feeds to the data communicator 15 and timing control signal transmitter 13 an interrupting signal 120 indicative of the interrupting cycle (step S13). Therefore, in the response to the interrupting signal 120, the controller 17 can interrupt the transmission of the data signal 116 and timing control signal 110 in the time slot of that node during the interrupting cycle.

For example, in the case where the transmission cycle information of a certain node indicates that a data signal is transmitted at the ratio of one to two cycles, in the time slot acquired in that node, a data signal 116 is transmitted in the cycle where a timing control signal 110, containing the transmission cycle information of that node, was transmitted.

However, when an interrupting signal 120, indicating that the subsequent cycle is an interrupting cycle, is fed to the data communicator 15 and timing control signal 110 transmitter 13, the timing control signal 110 and data signal 116 are not transmitted in the time slot of that node in the subsequent cycle. Thus, the data communicator 15 and timing control signal transmitter 13 go to an interrupted state.

In the manner described above, the node uses the transmission cycle information 112 of that node itself to control the transmission of the data signal 116 and timing control signal 110 in that node itself, whereby the power consumption related to that transmission can be saved.

Now, another operation of communication control of the illustrative embodiment will be described with reference to FIGS. 1, 2 and 4 where the node in question uses the transmission cycle information of another node received from the other node to control the reception of data signals and timing control signals in that node in question.

FIG. 4 is a flow chart for use in understanding the processing steps that are executed by the transmission-reception interruption controller 17 when receiving a data signal and a timing control signal.

Referring first to FIG. 2B, the timings at which the node of interest D receives a data signal 114 from nodes A and B are shown at intervals of one cycle. In the figure, with the horizontal axis as time, the time intervals represented by letters A and B in the figure are time slots acquired by nodes A and B, respectively. By way of example, the node A is assumed to transmit a data signal 116 at the ratio of one to three cycles, and the node B is assumed to transmit a data signal 116 at the ratio of one to five cycles, see FIG. 2A.

To begin with, the nodes A and B transmit timing control signals 110 which contain the transmission cycle information 112 of that node itself and destination information, as set forth above.

If the timing control signals 110 from the nodes A and B are received by the timing control signal receiver 11 of the node of interest D (step S21), then the destination information and the transmission cycle information 106 of another node are extracted from the timing control signals 110 by the timing control signal receiver 11.

After the “transmission cycle information 106 of another node” extracted is fed to the transmission-reception interruption controller 17, the controller 17 determines, on the basis of the contents of the “transmission cycle information 106 of the other node”, the cycles (interrupting cycles) during which the nodes A and B do not transmit data signals 116 and timing control signals 110 (step S22) and then confirms the respective time slots of the nodes A and B (step S23).

Then, the transmission-reception interruption controller 17 determines whether or not the destination information, contained in the timing control signal 110 received from each of the nodes A and B, indicates the node of interest D, i.e. that node itself, (step S24).

When the destination information indicates the node of interest D, i.e. when a source node transmits a data signal to the node of interest D, the transmission-reception interruption controller 17 of the node D feeds to the data communicator 15 and timing control signal receiver 11 an interrupting signal 120 indicative of the interrupting cycles and time slots of the nodes A and B (step S25).

Therefore, based on the timing at which the timing control signals 102 were received, i.e. based on the timing at which two pieces of transmission cycle information were acquired, the node D can find at the ratio of one to what cycles each node transmits a data signal 110. In addition, in the time slots where the source nodes do not transmit data signals 110, the node D causes the data communicator 15 and timing control signal receiver 11 to go to an interrupted state, thereby being able to save the power that is to be consumed in the state of waiting for data signals 116 and timing control signals 110.

For example, in the case of FIG. 2B, in the time slots acquired by the node A, the node A receives a data signal 114 at the ratio of one to three cycles and goes to an interrupted state in the remaining two time slots. Similarly, the node B receives a data signal 114 at the ratio of one to five cycles and goes to an interrupted state in the remaining four time slots.

In this way, the node of interest can use the transmission cycle information 106 of another node to perform the reception of data signals 114 and timing control signals 102 in that node itself only in the time slots where the other node transmit data signals 116 and timing control signals 110, so that the power consumption in the signal waiting can be saved.

On the other hand, in step S24, when the destination information does not indicates the node of interest D, i.e. when a source node does not transmit a data signal to the node of interest D, the transmission-reception interruption controller 17 of the node D feeds an interrupting signal 120 only to the timing control signal receiver 11 (step S26).

Thus, a node of interest is able to save the power consumption relating to the reception of data signals, while allowing its neighboring nodes to acquire time slots from each other by interchanging timing control signals.

For instance, as shown in FIG. 2A, within the reachable range 22 of the timing control signals 110 of the node of interest D, there are two or more nodes where the destination of data signals 116 is not the node of interest D. In such a case, it is necessary to acquire the time slots of these other nodes within one cycle.

Hence, the node of interest D, while allowing these other nodes to allocate time slots from each other, causes the timing control signal receiver 11 to go to an interrupted state, on the basis of the transmission cycle information attached to the timing control signal 110 transmitted from each of these other nodes. Therefore, because the node D does not have to receive data signals 114, the data communicator 15 can always go to an interrupted state in the above-described time slots.

As set forth above, according to the illustrative embodiment, in the data communication method in which the communication-timing is adjusted autonomously and dispersedly by transmitting and receiving timing control signals between two or more nodes, the transmission-reception interrupting controller and transmission cycle decider are additionally included, whereby each node autonomously controls the interruption of transmission and reception in accordance with the occurrence frequency of traffic.

Thus, in the period during which a transmitting node transmits no data signal, a receiving node goes to a reception waiting state, whereby wasteful power consumption is avoided. In addition, a transmitting node itself is able to save, in the period during which no traffic occurs, the power consumption relating to transmission.

Consequently, according to the illustrative embodiment, it is possible to save power for nodes under the circumstance where the occurrence frequency of traffic varies spatially with time.

It is noted that the present invention is not particularly limited in transmission and reception of timing control signals between nodes, so long as they can transmit and receive desired timings therebetween. The simplest example of a timing control signal is a single pulse that has a function waveform, such as a Gaussian waveform, a rectangular waveform and the like. However, a timing control signal need not always be a single pulse, and two or more pulses may be used to constitute a timing control signal that forms one meaning. For instance, a pulse train corresponding to a predetermined bit pattern may be handled as one impulse signal. Such a signal is used effectively when it is difficult to identify signals with a single pulse under the environment where there are many noise signals. While the timing control signal in the preferred embodiment of the present invention conceptually indicates a desired timing, the timing control signal may be implemented in various manners.

A merged signal of the above-mentioned timing control signal, e.g. a signal indicative of a specific timing, with some type of data such as a node identification number may be used as an impulse signal. Note that such a merged signal may also be implemented in various manners.

The communication timing calculator 12 may also be actualized in various ways insofar as they generate phase signals.

In the system as described in the form of illustrative embodiment, it is assumed that two or more nodes dispersedly disposed in space transmit and receive data from each other by radio. However, the present invention is not to be interpreted as being limited to such a wireless communication system. The present invention is also applicable to systems in which a great number of nodes dispersedly disposed in space transmit and receive data from each other over wires. For instance, the present invention is likewise applicable to wired local are a network (LAN) system, such as an Ethernet (trademark). Moreover, the present invention may be applied to networks in which different categories of nodes, such as wired sensor nodes, actuator nodes, and server nodes, exist together. It is a matter of course that the present invention can be applied to networks in which wired nodes and wireless nodes exist together.

Furthermore, the present invention can be used as a communication protocol for routers to interchange routing tables at different timings on the Internet. The router selects an appropriate pathway on the network for information and routes the information to its destination accordingly, i.e. is a relay device with a pathway selection function. The routing table is a pathway selection rule which is referred to when routing information to its destination. To achieve efficient communication, it is necessary to keep updating the routing tables in response to changes in network topology, local traffic changes and so forth. Because of this, routers on the network interchange mutually routing tables at predetermined intervals.

However, as disclosed by S. Floyd et al., “The Synchronization of Periodic Routing Message,” IEEE/ACM Trans. Networking, Vol. 2, No. 2, pp. 122 to 136, April 1994, it has been found a problem that even if routers transmit routing tables to each other at respective timings, these transmission timings will be gradually synchronized or collide with each other. Floyd et al., has proposed a method of working on this problem by giving random variation to the processing cycle of each node with respect to a communication protocol used for exchanging routing tables, and indicated that the method produces a certain effect. However, the method disclosed by Floyd et al., depends upon only randomness basically, so it is insufficiently effective.

In contrast, if the present invention is applied in order to settle the above-described problem, it is possible for neighboring routers to autonomously adjust time slots in which they transmit routing tables therebetween. Consequently, the transmission timings of the routers differ from each other. Thus, the present invention is capable of producing a better effect than the method taught by Floyd et al.

As has been described hereinbefore, the present invention is able to deal with the problem with regard to collisions and synchronization of transmission data in various networks, regardless of whether they are wireless systems or wired systems. Therefore, the present invention can be used as a communication protocol that realizes efficient data communication having adaptability and stability.

With respect to control for acquire communication timing information, i.e. phase signals in the preferred embodiment, the timing information may be variously used in communication. For instance, in the case where nodes transmit data signals at difference frequencies, they may communicate with each other without allocating time slots. Even in this case, they may use communication timing information to determine when to initiate data communication.

The functions of each node described in the illustrative embodiment can be implemented as software. However, if circuitry can be formed to have the same functions as the node, then it may be mounted on each node as hardware.

The entire disclosure of Japanese patent application No. 2007-096476 filed on Apr. 2, 2007, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A communication controller mounted on a network node constituting a communication system, comprising:
a data communicator for transmitting and receiving a data signal to and from other nodes forming the system;
a transmission cycle information decider for deciding transmission cycle information of the node on which said controller is mounted on a basis of occurrence frequency of traffic in said data communicator;
a timing control signal receiver for receiving a timing control signal transmitted from neighboring one or more of the other nodes, the timing control signal being indicative of a communication timing of the neighboring node;
a communication timing calculator for calculating a communication timing of the node on which said controller is mounted in accordance with a communication timing calculation rule, in response to reception of the timing control signal from the neighboring node;
a timing control signal transmitter for transmitting a merged signal of a timing control signal indicative of a communication timing of the node on which said controller is mounted and at least the transmission cycle information to the neighboring nodes; and
a transmission-reception interruption controller for determining whether or not to interrupt transmission and/or reception of the data signal and/or the timing control signal in the node on which said communication controller is mounted on the basis of transmission cycle information of the neighboring node contained in the timing control signal from the neighboring node or the transmission cycle information in the node on which said communication controller is mounted.

2. The communication controller in accordance with claim 1, wherein said transmission cycle decider decides the occurrence frequency of traffic on the basis of a data quantity of the data signal that is transmitted over a predetermined cycle by said data communicator.

3. The communication controller in accordance with claim 1, wherein said transmission-reception interruption controller causes said data communicator and said timing control signal transmitter to go to an interrupted state during an interrupting cycle of the node on which said communication controller is mounted that is determined on the basis of the transmission cycle information of the node on which said communication controller is mounted.

4. The communication controller in accordance with claim 1, wherein said transmission-reception interruption controller causes said data communicator and said timing control signal transmitter to go to an interrupted state, in a time slot of the neighboring node during an interrupting cycle of the neighboring node that are determined on the basis of the transmission cycle information of the neighboring node.

5. A network node constituting a communication system and comprising a communication controller which comprises:
a data communicator for transmitting and receiving a data signal to and from other nodes forming the system;
a transmission cycle information decider for deciding transmission cycle information of said network node on a basis of occurrence frequency of traffic in said data communicator;
a timing control signal receiver for receiving a timing control signal transmitted from neighboring one or more of the other nodes, the timing control signal being indicative of a communication timing of the neighboring node;
a communication timing calculator for calculating a communication timing of said network node in accordance with a communication timing calculation rule, in response to reception of the timing control signal from the neighboring node;
a timing control signal transmitter for transmitting a merged signal of a timing control signal indicative of a communication timing of said network node and at least the transmission cycle information to the neighboring nodes; and
a transmission-reception interruption controller for determining whether or not to interrupt transmission and/or reception of the data signal and/or the timing control signal in said network node on the basis of transmission cycle information of the neighboring node contained in the timing control signal from the neighboring node or the transmission cycle information in said network node.

6. A communication system comprising a plurality of network nodes, each of which comprises a communication controller which comprises:
a data communicator for transmitting and receiving a data signal to and from other nodes forming said system;
a transmission cycle information decider for deciding transmission cycle information of the node on which said communication controller is mounted on a basis of occurrence frequency of traffic in said data communicator;
a timing control signal receiver for receiving a timing control signal transmitted from neighboring one or more of the other nodes, the timing control signal being indicative of a communication timing of the neighboring node;
a communication timing calculator for calculating a communication timing of the node on which said communication controller is mounted in accordance with a communication timing calculation rule, in response to reception of the timing control signal from the neighboring node;
a timing control signal transmitter for transmitting a merged signal of a timing control signal indicative of a communication timing of the node on which said communication controller is mounted and at least the transmission cycle information to the neighboring nodes; and
a transmission-reception interruption controller for determining whether or not to interrupt transmission and/or reception of the data signal and/or the timing control signal in the node on which said communication controller is mounted on the basis of transmission cycle information of the neighboring node contained in the timing control signal from the neighboring node or the transmission cycle information in the node on which said communication controller is mounted.

7. A method of controlling communication in a communication controller mounted on a network node constituting a communication system, comprising the steps of:
transmitting and receiving a data signal to and from other nodes by a data communicator;
deciding transmission cycle information of the network node by a transmission cycle information decider on a basis of occurrence frequency of traffic in the data communicator;
receiving, in a timing control signal receiver, a timing control signal transmitted from neighboring one or more of the other nodes, the timing control signal being indicative of a communication timing of the neighboring node;
calculating a communication timing of the network node by a communication timing calculator in accordance with a communication timing calculation rule, in response to reception of the timing control signal from the neighboring node;
transmitting a merged signal of a timing control signal indicative of a communication timing of the network node and at least the transmission cycle information from a timing control signal transmitter to the one or more neighboring nodes; and
determining by a transmission-reception interruption controller whether or not to interrupt transmission and/or reception of the data signal and/or the timing control signal in the network node on the basis of transmission cycle information of the neighboring node contained in the timing control signal from the neighboring node or the transmission cycle information of the network node

8. A communication control program executable on a computer serving as a communication controller mounted on a network node constituting a communication system, said program causing the computer to function as:
a data communicator for transmitting and receiving a data signal to and from other nodes;
a transmission cycle information decider for deciding transmission cycle information of the node on which said controller is mounted on a basis of occurrence frequency of traffic in said data communicator;
a timing control signal receiver for receiving a timing control signal transmitted from neighboring one or more of the other nodes, the timing control signal being indicative of a communication timing of the neighboring node;
a communication timing calculator for calculating a communication timing of the node on which said controller is mounted in accordance with a communication timing calculation rule, in response to reception of the timing control signal from the neighboring node;
a timing control signal transmitter for transmitting a merged signal of a timing control signal indicative of a communication timing of the node on which said controller is mounted and at least the transmission cycle information to the neighboring nodes; and
a transmission-reception interruption controller for determining whether or not to interrupt transmission and/or reception of the data signal and/or the timing control signal in the node on which said communication controller is mounted on the basis of transmission cycle information of the neighboring node contained in the timing control signal from the neighboring node or the transmission cycle information of the node on which said communication controller is mounted.
